(19) United States
(12) Patent Application Publication
(10) Pub. No.: US 2024/0025015 A1
(43) Pub. Date: Jan. 25, 2024

(54) SCARFING MACHINE

(71) Applicant: LM WIND POWER A/S, Kolding (DK)

(72) Inventor: John ARSENEAUX, Kolding (DK)

(21) Appl. No.: 18/265,512

(22) PCT Filed: Dec. 15, 2021
(86) PCT No.: PCT/EP2021/085996

§ 371 Date: Jun. 6, 2023

(30) Foreign Application Priority Data
Dec. 16, 2020 (GB) 2019872.7

(51) Int. Cl. B24B 55/03; B24B 21/00

(52) U.S. Cl. CPC B24B 55/03; B24B 21/006

(57) ABSTRACT

A scarfing machine includes a base and a pair of platens adjustably positioned on the base. The pair of platens are configured as an upper platen and a lower platen such that the upper platen is fixed to the base and the lower platen is adjustably positioned on the base, to receive and support a member for scarfing. Also, at least one platen of the pair of platens is hollow and is defined with an inlet port and an outlet port. The scarfing machine further includes a scarfing tool, extending from either side and along a length of at least one of the pair of platens, to scarf the member supported between the pair of platens. The scarfing machine also includes a cooling circuit, fluidly connectable to the inlet port and the outlet port of the at least one platen of the pair of platens.

This invention generally relates to scarfing machines and more specifically to a scarfing machine use for scarfing a carbon pultruded material. Further embodiments of the disclosure relates to the scarfing machine employed with cooling mechanism.

### BACKGROUND

Scarfing is a machining process involving material removal from a surfaces of a structure or member, where said material are selectively removed to subject the structure for further processing such as, but not limited to, joining, assembling, machining, forming, and the like. In general, scarfing process is considered for improving and/or modifying surface parameters of the structure, which may be at least one of flattened surface texture, providing chamfer or rounded edges, and any other machining operation that may be performed on surface, that may be necessary for processing the structure.

Conventional scarfing machines that are available in the industry may include a scarfing tool, which may be manually operated by a skilled operator for scarfing a surface of the structure to be processed. Also, the conventional scarfing tools may be handheld and portable, whereas such tools may not be a viable option for scarfing structures of large dimensions. To address such requirements, tabletop scarfing machines have been developed with advent of technology, where scarfing tools are suitably positioned on a top surface of a table and may be set apart by a defined distance to adequately accommodate the structures having large dimensions. With such an arrangement, the structure may be rigidly clamped on the top surface of the table for subjecting to scarfing process. Clamping of the structure relative to the surface of the scarfing machines may generally be performed by a skilled operator, whereby clamping, and aligning the structure relative to the scarfing tools may be manually performed, which may be tedious and cumbersome.

In addition, during scarfing the structure, heat may be generated in the scarfing tool and at the surface of the structure due to frictional engagement therebetween. Such heat may not be uniformly distributed across the surface of the structure or may even be undesirable for processing of the structure, as such in case of structures being made from materials including, but not limited to carbon, or any other material which may be affected due to generation of heat during scarfing. Heat generated may cause damages to feature of the structure including, but not limited to, surface finishing, melting of material composition of the structure, and any other damage that may be considered undesirable or as a defect. A commonly known process for regulating and/or reducing such heat generation is by periodically spraying or supplying a coolant at the interface of the scarfing tool and the surface to structure, however, such spraying and/or supplying of coolant may interfere with scarf dust that may be in the form of chips, pieces, bits, fragments and the like, resulted from material removal at surface of the structure during the scarfing process. Also, interference of the coolant and the scarf dust may result in formation of clumps or debris on surface of the structure, that may inherently affect operation of the scarfing machine such as, but not limited to, regular requirement for cleaning and servicing, can obstruct progression or movement of the structure relative to the scarfing tool or vice versa, and during surface finishing of the structure.

There remains scope for improving the scarfing machine and its sub-assemblies to eventually improve overall performance of scarfing.

### BRIEF DESCRIPTION

According to a first aspect of the present invention, a scarfing machine is disclosed. The scarfing machine includes a base, and a pair of platens adjustably positioned on the base. The pair of platens are configured as an upper platen and a lower platen such that at least one of the pair of platens is fixed to the base and an other adjustably positioned on the base. Further, the pair of platens is displaceable to receive and support a member for scarfing. Also, at least one platen of the pair of platens is hollow and is defined with an inlet port and an outlet port. The scarfing machine further includes a scarfing tool, positioned on the base. The scarfing tool extends from either sides and along a length of at least one of the pair of platens and is selectively operable to scarf the member supported between the pair of platens. The scarfing machine also comprises a cooling circuit, fluidly connectable to the inlet port and the outlet port of the at least one platen of the pair of platens. The cooling circuit is configured to supply coolant through the at least one platen to extract heat generated during scarfing of the member.

In a preferred embodiment, the scarfing machine includes an actuation mechanism coupled to the lower platen of the pair of platens. The actuation mechanism is configured to selectively displace the lower platen relative to the upper platen. Preferably, the actuation mechanism is operable by at least one of a pedal and an actuator.

In one embodiment, the cooling circuit includes a storage tank configured to receive and supply coolant and a pump fluidly connecting the storage tank, the inlet port and the outlet port of the at least one platen. The pump is configured to supply the coolant through the cooling circuit. The cooling circuit further includes a chiller, configured to selectively cool the coolant returning from the at least one platen.

In one embodiment, the scarfing tool includes a rotary actuator, supported by the base and a pair of rollers, positioned at either ends of the upper platen and supported by the base. The scarfing tool further includes a scarfing belt, riding along at least portion of each of the pair of rollers through a rotating hub of the rotary actuator. The scarfing belt is configured to selectively engage the member, for scarfing.

In another embodiment, the scarfing machine includes one or more sensors configured to detect temperature of at least one of the coolant, the member, an interface between the member and at least one platen of the pair of platens. A control unit associated with the cooling circuit, is communicatively coupled to the one or more sensors. The control unit is configured selectively operate the cooling circuit based on the signal received from the one or more sensors.

Preferably each platen of the pair of platens in the scarfing machine is hollow and is defined with the inlet port and the outlet port, to receive the coolant from the cooling circuit.

Preferably the member is at least a pultruded carbon sheet and the coolant is water, for scarfing process by the above the scarfing machine.

According to second embodiment of the invention, a system for cooling of a scarfing machine is disclosed. The system includes a cooling circuit, fluidly connectable to at least one platen of the pair of platens. A control unit associated with the cooling circuit is configured to determine increase in temperature of at least one of the coolant, the member, an interface between the member and at least one platen of the pair of platens. The control unit receives signals from one or more sensors, based on which the control unit is configured to operate the cooling circuit based on the determination to supply coolant through the at least one platen to extract heat generated during scarfing of the member.

According to a third embodiment of the invention, a self-adjusting mechanism for a scarfing machine is disclosed. The mechanism includes a detector module configured to detect position and movement of the member and relative displacement of the pair of platens. The mechanism further includes an actuation mechanism, which can be coupled to the lower platen of the pair of platens, to selectively displace the lower platen relative to the upper platen. The mechanism also includes a control unit, which is communicatively coupled to the detector module and the actuation mechanism. The control unit is configured to determine position of the member and the pair of platens from a position reference signal generated by the detector module. Based on the position reference signal received from the detector module, the control unit is configured to operate the actuation mechanism to displace the lower platen relative to the upper platen of the pair of platens, to selectively engage the member for gripping and adjusting relative to that of the pair of platens.

Various other features will be apparent from the following detailed description and the drawings.

### BRIEF DESCRIPTION OF THE DRAWINGS

An example of the present invention will now be described with reference to the following drawings in which:

FIG. 1. illustrates a schematic diagram of a scarfing machine,

FIG. 2 illustrates a block diagram of the scarfing machine in FIG. 1,

FIG. 3 illustrates a schematic representation of an adjustment mechanism of the scarfing machine in FIG. 1,

FIG. 4 illustrates a magnified schematic view of a portion of a base in the scarfing machine of FIG. 1,

FIG. 5 illustrates a schematic representation of a cooling circuit in the scarfing machine,

FIG. 6 illustrates a schematic diagram of a support column for a scarfing tool of the scarfing machine, and

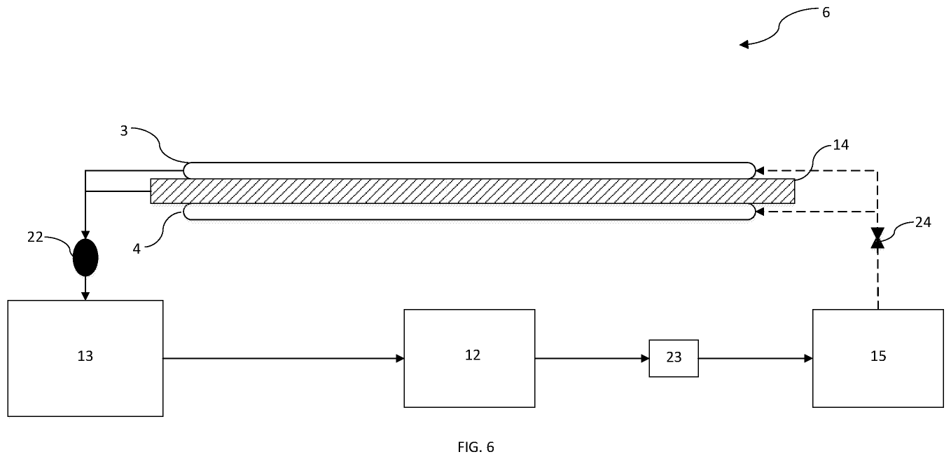

FIG. 7 illustrates a flow chart of method for cooling in the scarfing machine.

### DETAILED DESCRIPTION

This invention includes embodiments that relate to scarfing machines and more specifically to a cooling circuit and a self-adjustment mechanism for scarfing machines. However, such a circuit and mechanism can be readily applicable to other types of machines including but not limited to, milling machine, grinding machine, hobbing machine, and any other machine that may be manually operable or be computer operated

It shall be emphasized that with the term “member” is meant to include a sheet, a tube, a laminate, and any other category of workpiece that can be accommodated at a scarfing region of the scarfing machine.

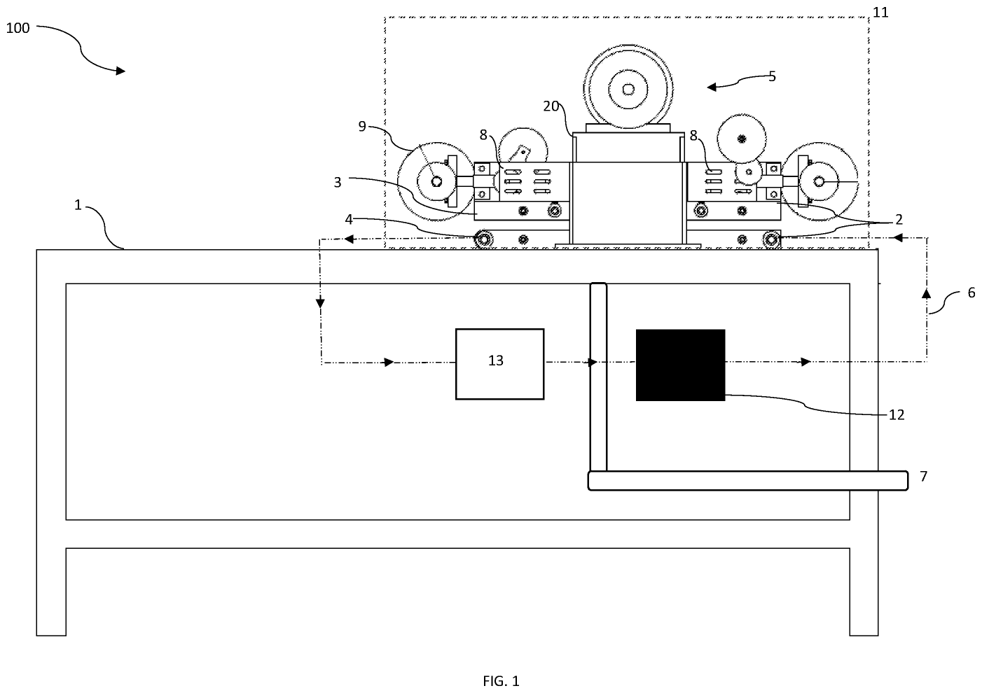

FIG. 1 illustrates a schematic diagram of a scarfing machine 100. The scarfing machine 100 includes a scarfing tool 5, enclosed within a housing 11. The scarfing tool 5 and the housing 11 are arranged on a base 1, which may be including, but may not be limited to, a platform, a table, a portion of a conveyer system or may preferably be any support surface about which scarfing process may be carried out. The housing 11 is arranged on the base 1 to define a scarfing region thereabout, for receiving and accommodating a member 14 on the base 1, for performing scarfing process as per requirements. The member 14 may be subjected to scarfing process for suitably dimensioning. The term “dimensioning” may refer to reduction in shape, size and/or structural configuration of the member 14 due to scarfing along at least one of length, width, thickness, radius or radii and edge length at intersection(s) of such length, width and/or thickness of the member 14.

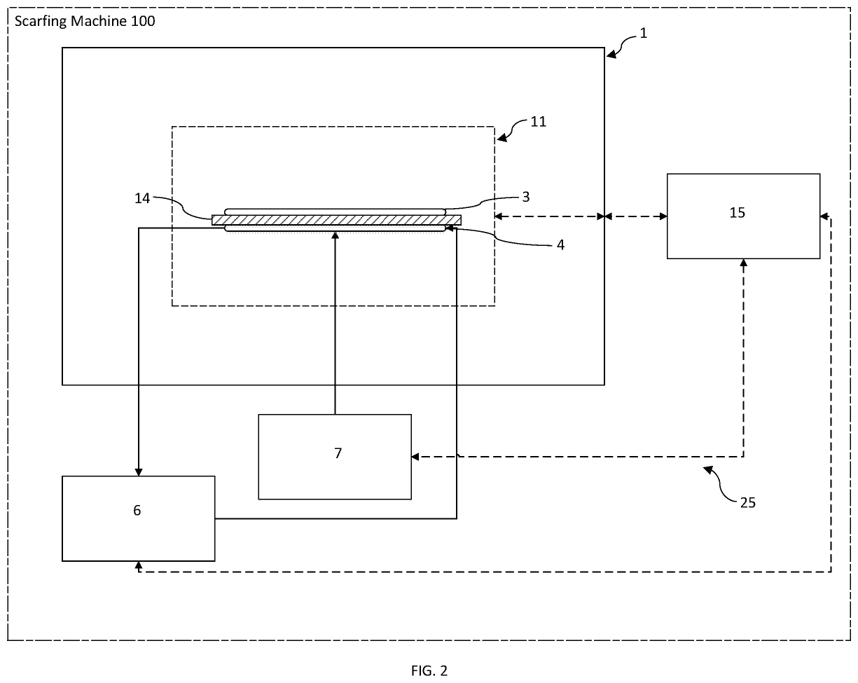

The scarfing machine 100, as depicted in block 201 diagram of FIG. 2, includes a cooling circuit 6 and a self-adjusting mechanism 25, for optimizing performance of the scarfing machine 100 and reduce operator intervention during scarfing process. Aspects related to the cooling circuit 6 and the self-adjusting mechanism 25 of the scarfing machine 100 as described below, however, such description should not be considered as a limitation of the invention, as other embodiments or alternatives can be easily derived by a skilled person from such description.

Referring again to FIG. 1, the scarfing machine 100 includes a scarfing tool 5, partially or completely enclosed within the housing 11. The scarfing tool 5 is either fixed to the base 1 or is positioned on a maneuvering mechanism, that can impart mobility to the scarfing tool 5, along with the housing 11. With such maneuvering mechanism, the scarfing tool 5 is displaceable relative to the member 14 and about the scarfing region on the base 1, for scarfing along a defined parameter of the member 14. Whereas, when the scarfing tool 5 is fixed to the base 1, the member 14 is either mobile or fixed to the base 1. While the member 14 can be mobile relative to the scarfing tool 5 and along the base 1, enabling the scarfing tool 5 to engage selective sections of the member 14 required to be scarfed. The scarfing tool 5 is configured to engage relative sections of the member 14 that are supported at the scarfing region.

The member 14 is supported on the base 1 while being engaged by the scarfing tool 5, where the scarfing machine 100 includes a gripping mechanism to rigidly and yet removably support the member 14 in the scarfing region. The gripping mechanism may include a pair of platens 2 that may be connected to the base 1. The pair of platens 2 may be provisioned on each side of the scarfing region or may be located on at least one side of such scarfing region, or yet on two opposing sides of the scarfing region, to secure and support the member 14 on the base 1 and about the scarfing region. The scarfing tool 5 may extend along a length of at least one of the pair of platens 2, to engage at least a section of the member 14 for scarfing process. The pair of platens 2 are positioned at the scarfing region, such that the member 14 may be supported at peripheral region or proximal thereto, based on section of the member 14 to be subjected for scarfing process and/or position of the scarfing tool 5 on the base 1. The pair of platens 2 may be configured to engage and support at two opposing surfaces or yet at two adjacent sides of the member 14, based on section of the member 14 to be subjected for scarfing process.

In the exemplary embodiment, the pair of platens 2 may be configured as an upper platen 3 and a lower platen 4, such that at least one platen of the pair of platens 2 is fixed to the base 1, while an other platen of the pair of platens 2 is adjustably positioned on the base 1. The upper platen 3 and the lower platen 4 of the pair of platens 2 is configured to engage and support the member 14 at two opposing surfaces, while section of the member 14 which may be adjacent or along the plane of one of the surfaces of the member 14 may be subjected to scarfing process. The upper platen 3 in the exemplary arrangement is connected to the base, whereas a lower platen 4 permissibly displaces relative to the upper platen 3, and in-turn about the scarfing region of the base 1. The base 1 may be defined with a cutout [not shown in Figures] enabling movement of the pair of platens 2, especially the lower platen 4, relative to the base 1 for engaging and accommodating the member 14 between each of the pair of platens 2. In an embodiment, the upper platen 3 of the pair of platens 2 may be either connected to the base 1 by either mechanical joining or thermal joining, or the upper platen 3 may be detachably connected by means such as, but not limited to, fastening, clamping, and any other non-permanent fixing means.

In one embodiment, the pair of platens 2 may also be slidably connected to the base 1 for variably adjusting position at which the member 14 may be engaged and supported therewith. Such variable adjustment of the pair of platens 2 enables scarfing at different sections of the member 14 including peripheral edges and proximal sections thereto of the member 14. For such variable adjustment, the upper platen 3 of the pair of platens 2 which may be connected to the base 1 may be railed on guideways or seated along ridges defined in the base 1. The upper platen 3 of the pair of platens 2 may slide or displace along such guideways or ridges in the base 1 to engage, receive and support the member 14, based on parameters such as, size and shape of the member 14, and also with respect to relative sections of the member 14 to be scarfed.

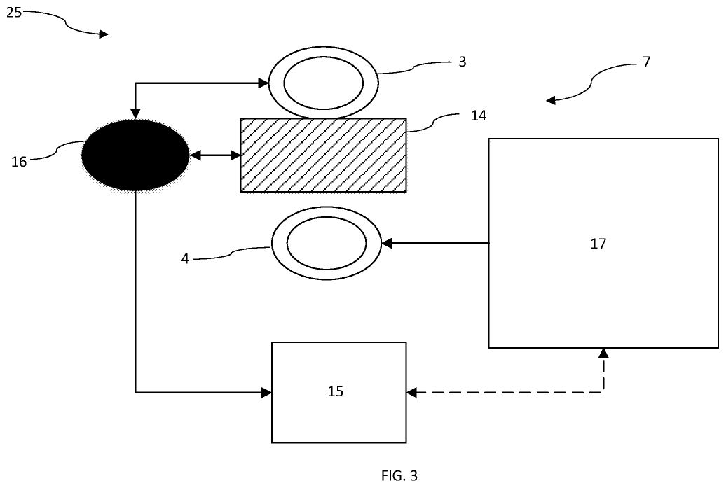

The pair of platens 2 of the scarfing machine 100 are included in the self-adjusting mechanism 25, where the pair of platens 2 are connectable to an actuation mechanism 7 and a detector module 16 of the self-adjusting mechanism 25, as shown in FIG. 3. The actuation mechanism 7 is coupled to at least one platen of the pair of platens 2 which is displaceable relative to the other platen and the base 1. In the exemplary machine, the actuation mechanism 7 is coupled to the lower platen 4 of the pair of platens 2. The actuation mechanism 7 is configured to selectively displace the lower platen 4 relative to the upper platen 3, and in-turn scarfing region on the base 1. The detector module 16 being a sensor or a transducer including, but not limited to, proximity sensor, Hall effect sensor, a magnetic sensor, a piezoelectric sensor, a Linear Variable Differential Transducer, or any other module to detect position and movement of the member 14 in the scarfing region and relative displacement of the pair of platens 2. The detector module 16 is coupled to a control unit 15, associated with the actuation mechanism 7 and/or the scarfing machine 100. The detector module 16 is further configured to generate a position reference signal to the control unit 15, indicating position and/or movement of the member 14 and each platen of the pair of platens 2. For the member 14 to be gripped in the scarfing region, the lower platen 4 is displaced away from the upper platen 3 to define a gap, in which the member 14 may be accommodated for scarfing. Upon positioning and accommodation of the member 14, the detector is configured to generate the position reference signal to the control unit 15. The control unit 15, based on the signal from the detector module 16, is configured to suitably displace the lower platen 4 for engaging the member 14. The lower platen 4 is displaced, i.e. either in vertical direction or horizontal direction or a combination thereof, by an actuator 17 of the actuation mechanism 7, to grip, adjust and/or align the member 14 with the upper platen 3. In another embodiment, the detector module 16 may further generate a second signal pertaining to position of the lower platen 4, to the control unit 15, for operating the scarfing tool 5 to scarf the member 14.

In the exemplary scarfing machine 100, the scarfing tool 5 is positioned on either sides of the pair of platens 2 and can extend along a length of at least one of the pair of platens 2. The scarfing tool 5 is selectively operated to scarf (remove or wear off at least a portion or section of) the member 14 with respect to at least one side or about one end of the pair of platens 2. Each platen of the pair of platens 2 can be of same length or of different lengths, to suitably allow engagement between the scarfing tool 5 and sections of the member 14 to be subjected to scarfing process. The scarfing tool 5 can be of myriad configurations that may enable selective engagement with the member 14, where configuration of the scarfing tool 5 may be one of rotary type, linear actuated type, and any other configuration that may enable engagement of the scarfing tool 5 with defined section of the member 14.

In an embodiment, for displacing the lower platen 4 relative to the member 14 and/or the scarfing region in the base 1, parameters including, but not limited to, material of the member 14, surface flatness of the member 14, thickness of the member 14, desired surface finish for the member 14, profile of each platen of the pair of platens 2 engaging the member 14, and any other parameter that may affect the scarfing process may be fed to the control unit 15. The control unit 15 may control the actuator 17 of the actuation mechanism 7 by an operation signal, to suitably displace the lower platen 4 for engaging the member 14. In an embodiment, the actuator 17 of the actuation mechanism 7 is operable by at least one of a foot pedal and an actuator 17. The actuator 17 may be a hydraulic arrangement, a pneumatic arrangement, a belt-motor arrangement, a gear arrangement, a manually-operated rotary wheel, and any other actuation mechanism 7 that can displace the lower platen 4 relative to the upper platen 3.

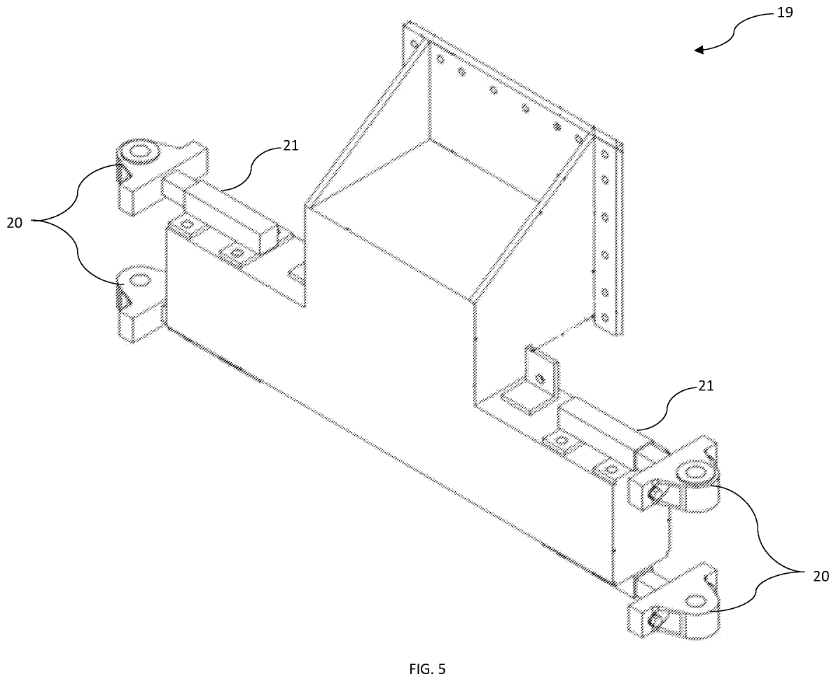

The scarfing tool 5 of the exemplary scarfing machine 100 includes a rotary actuator 8 and a pair of rollers 9. The rotary actuator 8 is supported on the base 1 via a support column 19, and the pair of rollers 9 is positioned at either ends of the upper platen 3, through a rotary hub 20 extending from the supported column, as can be seen in FIG. 5. The support column 19 and the rotary hub 20 provides adjustable means 21 for varying lateral or tangential distance between the pair of rollers 9 with ends or sides of the pair of platens 2, based on orientation and/or position of the pair of rollers 9 relative thereto. The adjustable means 21 may also be fixed to support the rotary hub 20, for scarfing process. The scarfing tool 5 further includes a scarfing belt 10, which rides along at least portion of each roller of the pair of rollers 9. The scarfing belt 10 is configured to selectively engage sections of the member 14, for scarfing. In another embodiment, the scarfing tool 5 may be a cutting insert, that can be embedded in the rotary hub 20 for engaging and scarfing sections of the member 14.

In relation to engagement between the scarfing tool 5 and the member 14, sections of the member 14 in contact with the scarfing tool 5 is subjected to localized heating due to frictional engagement therebetween, which in general, is non-uniformly distributed across at least one of the member 14 and in-turn to a portion of the pair of platens 2. To regulate such heat distribution in the member 14 and/or the pair of platens 2, the scarfing machine 100 includes the cooling circuit 6, which is fluidly connected to at least one of the pair of platens 2. The term “fluidly connected” and/or “fluidly coupled” are to be interpreted as a means included between components such as, but not limited to, the storage tank 12 and the pair of platens 2, for conveying or communication of fluid as that the coolant in the cooling circuit 6.

The cooling circuit 6 is connected to at least one platen of the pair of platens 2 to supply coolant therethrough so that, localized heat generated at interface between the member 14 and the scarfing tool 5 during scarfing process is extracted. At least one platen of the pair of platens 2 is defined to be hollow, including an inlet port and an outlet port defined at two opposing ends thereof, to be inclusive in the cooling circuit 6. In one embodiment, each platen of the pair of platens 2 can be hollow or can be defined to accommodate fluid supply conduits, for receiving and supplying the coolant in the cooling circuit 6. The coolant supplied through the at least one platen of the pair of platens 2 is configured to indirectly, i.e. through convection heat transfer and/or radiation heat transfer, extract heat generated due to localized contacts between the scarfing tool 5 with the member 14, and contact between the member 14 and the pair of platens 2. Such extraction of heat by the coolant mitigates direct interaction with the scarfing tool 5 and/or the member 14 during scarfing process.

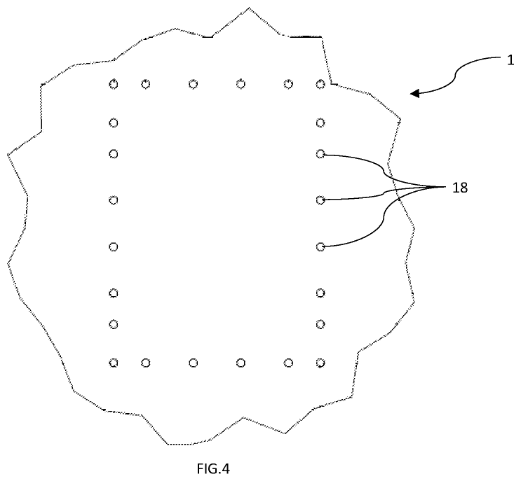

In another embodiment, typically, scarf dust is produced in form of chips, pieces, bits, powder or fragments of the member 14 during scarfing process, and such scarf dust may get coagulated when wetted by the coolant, due to spraying or impinging of the coolant on the scarfing tool 5 or the member 14. With such indirect heat extraction from the member 14 by the coolant in the exemplary scarfing machine 100, coagulation of the scarf dust over surface of the member 14 or at interaction between the member 14 and the pair of platens 2 can be avoided, as no wetting of such scarf dust occurs. As coagulation of the scarf dust is avoided in the exemplary machine, servicing time of the scarfing machine 100 and/or finishing process of the member 14 can be reduced. Servicing concerns related to leakage or seeping of coolant is in the scarfing region is also avoided on supplying such coolant through the at least one platen of the pair of platens 2. In yet another embodiment of the invention, the base 1 can be defined with a plurality of provisions 18, as best seen in FIG. 4, to channelize the scarfed dust from the housing 11 and in-turn the scarfing region. The plurality of provisions 18 are defined about an inner periphery of the housing 11 or dispersed in the scarfing region, to allow channelizing of the scarf dust, during scarfing process. The plurality of provisions 18 may be a through-hole or may be a conduit defined to allow passage of the scarf dust, where the plurality of provisions 18 may be including, but not limited to, groove, a ridge, a hole, and any other means to allow passage of the scarf dust from the housing 11. The invention can further include suction unit, that can be fluidly connected to at least one provision of the plurality of provisions 18. The suction unit is configured to draw the scarfed dust from the housing 11 through the plurality of provisions 18. The plurality of provisions 18 may be defined at corners of the housing 11, along edges of the housing 11, or at any portions of the base 1 in the scarfing region about which the scarf dust may be vented out therefrom.

Referring now to FIG. 5, the cooling circuit 6 in construction, includes a storage tank 12, configured to receive, store, and supply the coolant based on requirement. The storage tank 12 is fluidly connected to the outlet port of the at least one platen in the cooling circuit 6. The cooling circuit 6 further includes a pump 23, that fluidly connects the storage tank 12, the inlet port and the outlet port of the at least one platen. The pump 23 is configured to supply the coolant through the cooling circuit 6. Filters and valves 24 may also provided between the storage tank 12, the pump 23, the inlet port and the outlet port of the at least one platen, for regulating and selectively dispensing a predefined quantity of the coolant to extract heat generated during scarfing of the member 14. Such regulation and dispensing of the coolant in the cooling circuit 6 is performed by a control unit 15. The control unit 15 is associated with the cooling circuit 6 to maintain temperature of the member 14 within a defined limit during scarfing process. In an embodiment, the control unit 15 is communicatively coupled to one or more sensors 22 associated with the cooling circuit 6. The one or more sensors 22 are configured to detect temperature of at least one of the coolant, the member 14, the interface between the member 14 and at least one platen of the pair of platens 2. The one or more sensors 22 may be including, but not limited to, optical temperature sensors positioned outside the pair of platens 2 and proximal to the interface with the member 14, or an electronic sensors positioned on or inside at least one of the pair of platens 2 to detect temperature of the coolant, the member 14, the at least one platen or combination thereof. Based on detection, the one or more sensors 22 is configured to transmit a signal to the control unit 15, for determining temperature of at least one of the coolant, the member 14, an interface between the member 14 and at least one platen of the pair of platens 2, during the scarfing process. The control unit 15, based on determined temperature may compare with a pre-set data stored in a memory unit [not shown in figures] associated with the control unit 15 or the scarfing machine 100. The control unit 15, upon comparison of determined temperature with the pre-set values, can regulate flow rate of the coolant and/or temperature of the coolant through the cooling circuit 6, for optimizing power consumed by the scarfing machine 100.

In the exemplary embodiment, the cooling circuit 6 further includes a chiller 13, configured to selectively cool the coolant. The chiller 13 can be fluidly connected to the inlet port or at the outlet port of the at least one platen in the cooling circuit 6. The chiller 13 is configured to receive the coolant at an elevated temperature from the outlet port of the at least one platen and transmit a cooled coolant to the storage tank 12 for recirculation in the cooling circuit 6. Alternatively, the chiller 13 can be connected at the inlet port of the at least one platen in the cooling circuit 6 and downstream of the storage tank 12, to supply cooled coolant to the at least one platen. The chiller 13 can be a heat exchanger having any configuration which enables in regulating temperature of the coolant received from the at least one platen in the cooling circuit 6. The chiller 13 is further operationally connected to the control unit 15. The control unit 15 is configured to control operation of the chiller 13 to regulate temperature of the coolant being transmitted therefrom. Operation of the chiller 13 can be controlled by either controlling operational condition of the chiller 13, i.e. between ON condition and OFF condition, or controlling rate of cooling of the coolant in the chiller 13. The control unit 15 may operate the chiller 13 to ON condition and/or set rate of cooling to a defined value based on determined temperature on comparison with the pre-set data to regulate flow rate of the coolant and/or temperature of the coolant through the cooling circuit 6.

In one embodiment of the invention, the control unit 15 may be set with data pertaining to parameters of the scarfing process, to regulate flow rate of the coolant and/or temperature of the coolant through the cooling circuit 6. The parameters may be including, but not limited to, material from which the member 14 is made of, nature of scarfing tool 5, size of the scarfing region, scarfing time, characteristics of the coolant, and any other parameter that may affect cooling rate of the cooling circuit 6. The characteristics of the coolant may be such as, but not limited to, viscosity, freezing point, thermal conductivity, and any other property of the coolant that may vary cooling rate of the cooling circuit 6. For example, the member 14 being a pultruded carbon sheet and the scarfing belt 10 of the scarfing tool 5 being a sand belt accommodated between the pair of rollers 9, the coolant can be selected as water, while other coolants can also be selected based on parameters affecting the scarfing process.

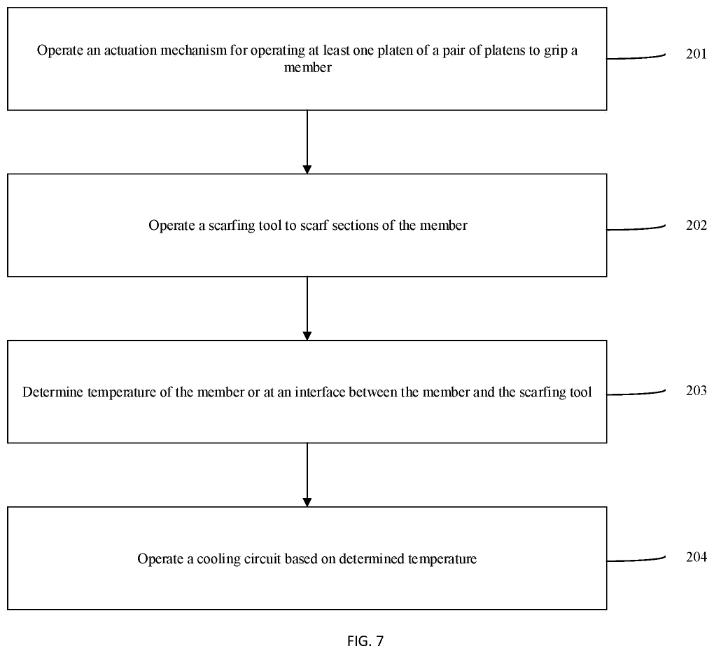

Referring now to FIG. 7 which is an exemplary embodiment of the invention illustrating a flow chart of a method of cooling in a scarfing machine 100. The method may describe in the general context of processor executable instructions in the control unit 15. Generally, the executable instructions may include routines, programs, objects, components, data structures, procedures, units, and functions, which perform particular functions or implement particular data types.

The order in which the method is described is not intended to be construed as a limitation, and any number of the described method blocks may be combined in any order to implement the method. Additionally, individual blocks may be deleted from the methods without departing from the scope of the subject matter described herein. Furthermore, the method can be implemented in any suitable hardware, software, firmware, or combination thereof.

At block 201, the control unit 15 is configured to operate the actuation mechanism 7 for operating at least one platen of the pair of platens 2, to define the gap therebetween. Dimension of the gap defined between the pair of platens 2 may be proportional to dimension of the member 14 about which the member 14 is to be gripped by the pair of platens 2. The control unit 15 on operating the actuation mechanism 7 to grip the member 14 by the pair of platens 2, is configured to operate the scarfing tool 5, as shown at block 202. The scarfing tool 5 is configured to scarf sections of the members. The scarfing tool 5 and/or the member 14 may be moveable relative to one another or with respect to the scarfing region of the base 1, for subjecting sections of the member 14 for scarfing process. During the scarfing process, frictional engagement may occur between the scarfing tool 5 and sections of the member 14, where such frictional engagement may result in localized heat which may be non-uniformly distributed across the member 14.

At block 203, the control unit 15 is configured to determine temperature of at least one of the coolant, the member 14, an interface between the member 14 and at least one platen of the pair of platens 2. The control unit 15 determines the temperature based on signals received from the one or more sensors 22 associated with the cooling circuit 6. The one or more sensors 22 are configured to detect temperature of the coolant, the member 14, the at least one platen and a combination thereof, during scarfing process. The one or more sensors 22 may be positioned at myriad of locations in the cooling circuit 6 for detecting temperature during the scarfing process, where position of the one or more sensors 22 may depend on working principle of such sensor. For example, an optic temperature sensor can detect temperature based on radiational wavelength from at least one component such as the member 14, and hence, can be distally positioned from such component. While electronic sensors such as a thermistor, requires physical contact with the component to determine temperature, and hence, can be positioned at a location where temperature may be required to be detected. Based on detection of the temperature, the one or more sensors 22 generate signal to the control unit 15 for determining temperature of various components and/or sections of such components, during scarfing process. The temperature is determined by the control unit 15 by comparison with the pre-set data associated with the scarfing process for a given material of the member 14, scarfing time, nature of scarfing tool 5, and characteristics of the coolant.

At block 202, the control unit 15 is configured to regulate operation of the cooling circuit 6, by regulating supply of the coolant. Supply of the coolant can be regulated by controlling either valves 24 or pumps 23 associated with the cooling circuit 6. Flow rate of the coolant can be controlled by controlling operation of the valve 24, while operation of the cooling circuit 6 can be turned to OFF condition by operating the pump 23 or valve 24 to OFF condition.

In an embodiment, when the pumps 23 associated with the cooling circuit 6 is operated to ON condition and the valves 24 are operated to allow flow of the coolant, the coolant is then supplied from the storage tank 12 to at least one platen of the pair of platens 2. The at least one platen of the pair of platens 2, being hollow and being thermally engaged with the member 14 during scarfing, allows flow of the coolant therethrough to thermally (and not physically or directly) engage at the interface between the member 14 and the pair of platens 2. The coolant is configured to thermally exchange heat content with the member 14, via at least one platen of the pair of platens 2, to mitigate heat distribution in the member 14. The rate of exchange of heat content between the coolant and the member 14 may be controlled by regulating temperature at which the coolant may be supplied to the at least one platen of the pair of platens 2. The coolant may then recirculated by channelizing through an outlet port of the at least one platen, to the storage tank 12 of the cooling circuit 6.

A technical contribution for the disclosed system and method is to provide an enhancement in performance of the scarfing machine 100; to achieve improved energy efficiency of scarfing process; and additionally, to minimize manufacturing lead time and reduce manual operator involvement of scarfing process.

While the invention has been described in detail in connection with only a limited number of embodiments, it should be readily understood that the invention is not limited to such disclosed embodiments. Further, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not limited by the foregoing description, but is only limited by the scope of the appended claims.

The following is a list of exemplary embodiments:
1. A scarfing machine (100), comprising:
   a base (1);
   a pair of platens (2), configured as an upper platen (3) and a lower platen (4), such that at least one of the pair of platens (2) is fixed to the base (1) and an other of the pair of platens (2) is adjustably positioned on the base (1), wherein the pair of platens (2) displaceable to receive and support a member (14) for scarfing, and wherein at least one platen of the pair of platens (2) is hollow and is defined with an inlet port and an outlet port;
   a scarfing tool (5) positioned on the base (1), the scarfing tool (5) extends from either sides and along a length of at least one of the pair of platens (2), wherein the scarfing tool (5) is selectively operable to scarf the member (14) supported between the pair of platens (2); and a cooling circuit (6), fluidly connectable to the inlet port and the outlet port of the at least one platen of the pair of platens (2), wherein the cooling circuit (6) is configured to supply coolant through the at least one platen to extract heat generated during scarfing of the member (14).
2. The scarfing machine (100) according to item 1, comprises an actuation mechanism (7) coupled to the lower platen (4) of the pair of platens (2), to selectively displace the lower platen (4) relative to the upper platen (3).
3. The scarfing machine (100) according to any item 2, wherein the actuation mechanism (7) is operable by at least one of a pedal and an actuator (17).
4. The scarfing machine (100) according to item 1, wherein the scarfing tool (5) comprises:
   a rotary actuator (8), supported by the base (1);
   a pair of rollers (9), positioned at either ends of the upper platen (3) and supported by the base (1); and
   a scarfing belt (10), riding along at least portion of each of the pair of rollers (9) through a rotating hub of the rotary actuator (8), wherein the scarfing belt (10) is configured to selectively engage the member (14), for scarfing.
5. The scarfing machine (100) according to item 1, comprises a housing (11) to enclose a scarfing region of the base (1).
6. The scarfing machine (100) according to any of the preceding items, wherein the base (1) is defined with a plurality of provisions (18) to channelize scarfed dust from the housing (11).
7. The scarfing machine (100) according to any of the preceding items, comprises a suction unit, configured to draw the scarfed dust from the housing (11) through the plurality of provisions (18).
8. The scarfing machine (100) according to item 1, wherein the cooling circuit (6) comprises:
   a storage tank (12), configured to receive and supply coolant; and
   a pump (23) fluidly connecting the storage tank (12), the inlet port and the outlet port of the at least one platen, wherein the pump (23) is configured to supply the coolant through the cooling circuit (6).
9. The scarfing machine (100) according to any of the preceding item, wherein the cooling circuit (6) further comprises a chiller (13), wherein the chiller (13) is configured to selectively cool the coolant returning from the at least one platen.
10. The scarfing machine (100) according to item 1, comprises one or more sensors (22) configured to detect temperature of at least one of the coolant, the member (14), an interface between the member (14) and at least one platen of the pair of platens (2).
11. The scarfing machine (100) according to item 9, comprises a control unit (15) associated with the cooling circuit (6), wherein the control unit (15) is communicatively coupled to the one or more sensors (22) and is configured selectively operate the cooling circuit (6) based on the signal received from the one or more sensors (22).
12. The scarfing machine (100) according to any of the preceding items, the member (14) is at least a pultruded carbon sheet.
13. The scarfing machine (100) according to any of the preceding items, wherein the coolant is water.
14. The scarfing machine (100) according to item 1, wherein each platen of the pair of platens (2) is hollow and is defined with the inlet port and the outlet port, to receive the coolant from the cooling circuit (6).
15. A system for cooling of a scarfing machine (100), wherein the scarfing machine (100) includes a base (1), a scarfing tool (5) positioned on the base (1), a pair of platens (2) having at least one of the pair of platens (2) defined with hollow structure, the system comprising:
   a cooling circuit (6), fluidly connectable to at least one platen of the pair of platens (2);
   a control unit (15) associated with the cooling circuit (6) and communicatively coupled to one or more sensors (22) associated with the cooling circuit (6), the control unit (15) is configured:
      determine increase in temperature of at least one of the coolant, the member (14), an interface between the member (14) and at least one platen of the pair of platens (2), based on the signals received from the one or more sensors (22); and
      operate the cooling circuit (6) based on the determination to supply coolant through the at least one platen to extract heat generated during scarfing of the member (14).
16. The system according to item 15, wherein the cooling circuit (6) comprises:
   a storage tank (12), configured to receive and supply coolant;
   a pump (23) fluidly connecting the storage tank (12) to one end of the at least one platen of the pair of platens (2), wherein the pump (23) is configured to supply the coolant through the cooling circuit (6); and
   a chiller (13) connectable between the storage tank (12) and the one end of the at least one platen of the pair of platens (2), the chiller (13) is configured to selectively cool the coolant returning from the at least one platen.
17. The system according to item 16, wherein the control unit (15) is coupled to at least one electrical valve (24) of the cooling circuit (6) and operates the at least one electrical valve (24) to selectively regulate supply of the coolant through the at least one platen.
18. A method of cooling a scarfing machine (100), wherein the scarfing machine (100) includes a base (1), a scarfing tool (5) positioned on the base (1), a pair of platens (2) having an upper platen (3) and a lower platen (4), where at least one of the pair of platens (2) being fixed to the base (1) and defined with hollow structure, the method comprising steps of:
   determining, by a control unit (15), temperature of at least one of the coolant, the member (14), an interface between the member (14) and at least one platen of the pair of platens (2), based on the signals received from one or more sensors (22); and
   regulating, by the control unit (15), operation of the cooling circuit (6) to supply coolant through the at least one platen to extract heat generated during scarfing of the member (14) based on the determination.
19. The method according to item 18, wherein regulating, by the control unit (15), the cooling circuit (6) is by controlling operation of at least one electrical valve (24) of the cooling circuit (6), to selectively regulate supply of the coolant through the at least one platen.
20. A method of operating a scarfing machine (100), the method comprising steps of:
   adjusting at least one platen of a pair of platens (2), to receive and support a member (14) for scarfing, the pair of platens (2) is configured as an upper platen (3) and a lower platen (4), such that at least one of the pair of platens (2) is fixed to a base (1) of the scarfing machine (100) and an other of the pair of platens (2) is adjustably positioned on the base (1), wherein at least one platen of the pair of platens (2) is hollow and is defined with an inlet port and an outlet port;
   positioning a scarfing tool (5) on the base (1) to extend from either sides and along a length of at least one of the pair of platens (2), wherein the scarfing tool (5) is selectively operable to scarf the member (14) supported between the pair of platens (2); and
   operating a cooling circuit (6) which is fluidly connectable to the inlet port and the outlet port of the at least one platen of the pair of platens (2), wherein the cooling circuit (6) is configured to supply coolant through the at least one platen to extract heat generated during scarfing of the member (14).
21. A self-adjusting mechanism (25) for a scarfing machine (100), wherein the scarfing machine (100) comprising a base (1) and a pair of platens (2) configured as an upper platen (3) and a lower platen (4) to support a member (14), the mechanism (25) comprising:
   a detector module (16), configured to detect position and movement of the member (14) and relative displacement of the pair of platens (2);
   an actuation mechanism (7) coupled to the lower platen (4) of the pair of platens (2), to selectively displace the lower platen (4) relative to the upper platen (3); and
   a control unit (15), communicatively coupled to the detector module (16) and the actuation mechanism (7), wherein the control unit (15) is configured to:
      determine position of the member (14) and the pair of platens (2) from a position reference signal generated by the detector module (16); and
      operate the actuation mechanism (7) to displace the lower platen (4) relative to the upper platen (3) of the pair of platens (2), to selectively engage the member (14) for gripping and adjusting relative to that of the pair of platens (2), based on the position reference signal received from the detector module (16).
22. The self-adjusting mechanism (25) according to item 21, wherein the actuation mechanism (7) is an actuator (17).

Referral numerals

Scarfing machine 100
Base 1
Pair of platens 2
Upper platen 3
Lower platen 4
Scarfing tool 5
Cooling circuit 6
Actuation mechanism 7
Rotary actuator 8
Rollers 9
Scarfing belt 10
Housing 11
Storage tank 12
Chiller 13
Member 14
Control unit 15
Detector module 16
Actuator 17
Provisions 18
Support column 19
Rotary hub 20
Adjustable means 21
Sensors 22
Pump 23
Valve 24
Self-adjusting mechanism 25

1. A scarfing machine (100), comprising:
a base (1);
a pair of platens (2) having at least one platen of the pair of platens (2) defined with hollow structure; and
a scarfing tool (5) positioned on the base (1);

2. A scarfing machine (100) according to claim 1, wherein
the pair of platens (2) is configured as an upper platen (3) and a lower platen (4), such that at least one of the pair of platens (2) is fixed to the base (1) and an other of the pair of platens (2) is adjustably positioned on the base (1), wherein the pair of platens (2) displaceable to receive and support a member (14) for scarfing, and wherein at least one platen of the pair of platens (2) is hollow and is defined with an inlet port and an outlet port;
wherein the scarfing tool (5) extends from either sides and along a length of at least one of the pair of platens (2), wherein the scarfing tool (5) is selectively operable to scarf the member (14) supported between the pair of platens (2); and wherein the scarfing machine (100) further comprises:
a cooling circuit (6), fluidly connectable to the inlet port and the outlet port of the at least one platen of the pair of platens (2), wherein the cooling circuit (6) is configured to supply coolant through the at least one platen to extract heat generated during scarfing of the member (14).

3. The scarfing machine (100) according to claim 2, comprises an actuation mechanism (7) coupled to the lower platen (4) of the pair of platens (2), to selectively displace the lower platen (4) relative to the upper platen (3).

4. The scarfing machine (100) according to claim 3, wherein the actuation mechanism (7) is operable by at least one of a pedal and an actuator (17).

5. The scarfing machine (100) according to claim 2, wherein the scarfing tool (5) comprises:
a rotary actuator (8), supported by the base (1);
a pair of rollers (9), positioned at either ends of the upper platen (3) and supported by the base (1); and
a scarfing belt (10), riding along at least portion of each of the pair of rollers (9) through a rotating hub of the rotary actuator (8), wherein the scarfing belt (10) is configured to selectively engage the member (14), for scarfing.

6. The scarfing machine (100) according to claim 2, comprises a housing (11) to enclose a scarfing region of the base (1).

7. The scarfing machine (100) according to claim 1, wherein the base (1) is defined with a plurality of provisions (18) to channelize scarfed dust from the housing (11).

8. The scarfing machine (100) according to claim 1, comprises a suction unit, configured to draw the scarfed dust from the housing (11) through the plurality of provisions (18).

9. The scarfing machine (100) according to claim 2, wherein the cooling circuit (6) comprises:
a storage tank (12), configured to receive and supply coolant; and
a pump (23) fluidly connecting the storage tank (12), the inlet port and the outlet port of the at least one platen, wherein the pump (23) is configured to supply the coolant through the cooling circuit (6).

10. The scarfing machine (100) according to claim 1, wherein the cooling circuit (6) further comprises a chiller (13), wherein the chiller (13) is configured to selectively cool the coolant returning from the at least one platen.

11. The scarfing machine (100) according to claim 2, comprises one or more sensors (22) configured to detect temperature of at least one of the coolant, the member (14), an interface between the member (14) and at least one platen of the pair of platens (2).

12. The scarfing machine (100) according to claim 10, comprises a control unit (15) associated with the cooling circuit (6), wherein the control unit (15) is communicatively coupled to the one or more sensors (22) and is configured selectively operate the cooling circuit (6) based on the signal received from the one or more sensors (22).

13. The scarfing machine (100) according to claim 1, the member (14) is at least a pultruded carbon sheet.

14. The scarfing machine (100) according to claim 1, wherein the coolant is water.

15. The scarfing machine (100) according to claim 2, wherein each platen of the pair of platens (2) is hollow and is defined with the inlet port and the outlet port, to receive the coolant from the cooling circuit (6).

16. A system for cooling of a scarfing machine (100) according to claim 1, the system comprising:
a cooling circuit (6), fluidly connectable to at least one platen of the pair of platens (2);
a control unit (15) associated with the cooling circuit (6) and communicatively coupled to one or more sensors (22) associated with the cooling circuit (6), the control unit (15) is configured:
determine increase in temperature of at least one of the coolant, the member (14), an interface between the member (14) and at least one platen of the pair of platens (2), based on the signals received from the one or more sensors (22); and
operate the cooling circuit (6) based on the determination to supply coolant through the at least one platen to extract heat generated during scarfing of the member (14).

17. The system according to claim 16, wherein the cooling circuit (6) comprises:
a storage tank (12), configured to receive and supply coolant;
a pump (23) fluidly connecting the storage tank (12) to one end of the at least one platen of the pair of platens (2), wherein the pump (23) is configured to supply the coolant through the cooling circuit (6); and
a chiller (13) connectable between the storage tank (12) and the one end of the at least one platen of the pair of platens (2), the chiller (13) is configured to selectively cool the coolant returning from the at least one platen.

18. The system according to claim 17, wherein the control unit (15) is coupled to at least one electrical valve (24) of the cooling circuit (6) and operates the at least one electrical valve (24) to selectively regulate supply of the coolant through the at least one platen.

19. A method of cooling a scarfing machine (100) according to claim 1 wherein the pair of platens (2) having an upper platen (3) and a lower platen (4), where at least one of the pair of platens (2) being fixed to the base (1) and defined with hollow structure, the method comprising steps of:
determining, by a control unit (15), temperature of at least one of the coolant, the member (14), an interface between the member (14) and at least one platen of the pair of platens (2), based on the signals received from one or more sensors (22); and
regulating, by the control unit (15), operation of the cooling circuit (6) to supply coolant through the at least one platen to extract heat generated during scarfing of the member (14) based on the determination.

20. The method according to claim 19, wherein regulating, by the control unit (15), the cooling circuit (6) is by controlling operation of at least one electrical valve (24) of the cooling circuit (6), to selectively regulate supply of the coolant through the at least one platen.

21. A method of operating a scarfing machine (100) according to claim 1, the method comprising steps of:
adjusting at least one platen of a pair of platens (2), to receive and support a member (14) for scarfing, the pair of platens (2) is configured as an upper platen (3) and a lower platen (4), such that at least one of the pair of platens (2) is fixed to a base (1) of the scarfing machine (100) and an other of the pair of platens (2) is adjustably positioned on the base (1), wherein at least one platen of the pair of platens (2) is hollow and is defined with an inlet port and an outlet port;
positioning a scarfing tool (5) on the base (1) to extend from either sides and along a length of at least one of the pair of platens (2), wherein the scarfing tool (5) is selectively operable to scarf the member (14) supported between the pair of platens (2); and
operating a cooling circuit (6) which is fluidly connectable to the inlet port and the outlet port of the at least one platen of the pair of platens (2), wherein the cooling circuit (6) is configured to supply coolant through the at least one platen to extract heat generated during scarfing of the member (14).

22. A self-adjusting mechanism (25) for a scarfing machine (100), wherein the scarfing machine (100) comprising a base (1) and a pair of platens (2) configured as an upper platen (3) and a lower platen (4) to support a member (14), the mechanism (25) comprising:
a detector module (16), configured to detect position and movement of the member (14) and relative displacement of the pair of platens (2);
an actuation mechanism (7) coupled to the lower platen (4) of the pair of platens (2), to selectively displace the lower platen (4) relative to the upper platen (3); and
a control unit (15), communicatively coupled to the detector module (16) and the actuation mechanism (7), wherein the control unit (15) is configured to:
determine position of the member (14) and the pair of platens (2) from a position reference signal generated by the detector module (16); and
operate the actuation mechanism (7) to displace the lower platen (4) relative to the upper platen (3) of the pair of platens (2), to selectively engage the member (14) for gripping and adjusting relative to that of the pair of platens (2), based on the position reference signal received from the detector module (16).

23. The self-adjusting mechanism (25) according to claim 22, wherein the actuation mechanism (7) is an actuator (17).
